(19) United States
(12) Patent Application Publication
(10) Pub. No.: US 2010/0163402 A1
(43) Pub. Date: Jul. 1, 2010

(54) SYSTEM FOR ALTERNATIVE FUEL WITH HIGH EFFICIENCY OF LOOP REACTOR AND METHOD THEREOF

(76) Inventor: Eun Ju Seo, Seoul (KR)

Correspondence Address: FAY SHARPE LLP, 1228 Euclid Avenue, 5th Floor, The Halle Building, Cleveland, OH, 44115, US

(21) Appl. No.: 12/294,698

(22) PCT Filed: Apr. 5, 2007
(86) PCT No.: PCT/KR2007/001666

§ 371 Date: Sep. 26, 2008

(30) Foreign Application Priority Data
Apr. 7, 2006 (KR) 10-2006-0031944

(51) Int. Cl. B06B 1/00; C10L 1/14

(52) U.S. Cl. 204/157.62; 422/128

(57) ABSTRACT

A system for producing a substitute fuel includes a loop reactor system that includes a loop type reactor equipped with at least one dual frequency irradiator to mix the reactants uniformly in the reactor and to accelerate the reaction. The system further includes an apparatus for feeding waste oil containing free fat acid or fat oil containing triglyceride, and an apparatus for feeding catalyst and methanol. A separation/extraction system is provided for separating the products produced in the loop reactor system into large and small particles and vaporizing low boiling point components. A phase (layer) separation system is provided for stabilizing the products. This system is equipped with a dual frequency phase separator and a vertical double baffle.

### TECHNICAL FIELD

The present invention relates to a system for producing substitute fuel using a loop reactor with high efficiency from a waste oil containing free fat acid or triglyceride of animal/vegetable fat oil. More particularly, the present invention primarily relates to a process of producing substitute fuel from a waste oil containing free fat acid through esterification with an acid catalyst. The esterification is a basic reaction for removing free fat oil when preparing substitute fuel with the waste oil. Further the present invention relates to a system for producing substitute fuel through trans-esterification of triglyceride that is a main component of fat oil.

### BACKGROUND ART

Two problems should be solved in order to obtain substitute fuel as a clean fuel. One is reduce the raw material cost, the other is reduce the excessive producing cost. The vegetable fat oil for using the raw material of substitute fuel are expensive for production, and the high cost of the raw material affects the cost of the substitute fuel. Considering such circumstance, the variety of the raw materials for substitute fuel is required. In addition, the reaction time for producing substitute fuel is long such as for half an hour to one hour, which results in high cost and low productivity. Such in-efficient process and system will cause a high increase of operating cost as well as production cost. A conventional diesel oil is cheaper than the substitute fuel, in terms of production cost. However, the conventional oil is on the market with a higher price than the substitute fuel due to the government tax. The price of the substitute fuel is important in the market.

Intensive researches have been conducted for developing new processes and systems for producing substitute fuel, and many patent applications have been filed in many counties. Korean Patent Application No. 2003-19649 discloses a process for producing a substitute fuel referred to as biodiesel oil by reacting fat oil with alcohol under a catalyst. Korean Patent Application No. 2001-79858 teaches a process for producing a biodiesel oil from an animal oil through trans-esterification. Korean Patent Application No. 2003-22078 discloses a method of removing free fatty oil from a waste oil in the preparation of a biodiesel oil.

Korean Patent Application No. 2004-42065 discloses an apparatus for mixing vegetable oil, alcohol and catalyst for producing a biodiesel oil. The processes and apparatus for producing a substitute fuel in the patent applications above do not solve the problems on the high cost and slow reaction like the conventional technology.

U.S. Pat. No. 6,884,900 B2 discloses a method for producing fat acid alcohol ester as a substitute fuel through an ester interchange reaction between fats or oils and alcohol by applying ultrasonic irradiation at a frequency of 15 to 100 kHz and an irradiation intensity of 0.5 to 20 W/□ in the presence of a catalyst. Korean Patent No. 361106 teaches a process for regenerating a waste oil or animal oil to obtain a substitute fuel for diesel fuel or boiler fuel, and Korean Patent No. 490116 discloser a process for producing a substitute fuel from a waste oil or animal oil by applying ultrasonic irradiation. However, the US patent and Korean Patents do not solve the reaction time problem.

The inventor of the present invention has conducted research for developing an advanced system to produce a substitute fuel. In particular, the inventor focused on the reaction time for producing a substitute fuel so as to reduce the reaction time because all the conventional processes have disadvantages due to the slow reaction rate.

In general, the conversion rate of reaction and the reaction time are important factors in chemical reaction. The slow reaction in the preparation of a substitute fuel is caused by bad mixing between the reactants, that is, fat acid or triglyceride with methanol. The reaction proceeds slowly because the polar and non-polar reactants are not mixed together well. An alkali or acid catalyst in the reaction is used to drive mixing of the reactants. In the conventional processes, a mixer, agitator, pump and the like are used with emulsifying agent to mix the reactants. A batch type reactor has been widely used for preparation of a conventional substitute oil, and sometimes a continuous stirring tank reactor or a pipe type reactor is used for a continuous reaction. However, such conventional mixing apparatuses and reactors do not help to reduce the reaction time.

The present invention focuses on the reaction using an ultrasonic irradiation and the reactor for a continuous reaction. Thus, the inventor tried to apply an ultrasonic irradiation during reaction, in particular, the inventor applied an ultrasonic irradiation with two different frequencies so as to maximize the mixing effect. Also, the inventor applied a loop rector in which the reaction time can be easily controlled and a continuous reaction can lie proceeded.

Unlike U.S. Pat. No. 6,884,900 B2 and Korean Patent Nos. 361106 and 490116 in which a single frequency is applied in the ultrasonic irradiation, a dual frequency irradiation is adopted in the present invention for perfect mixing and agitation of the reactants.

The dual frequency irradiation of the present invention can contribute to reduce the reaction time significantly and the excess feed of methanol, and even to proceed the reaction without a catalyst. And, the loop reactor of the present invention is applied for continuous production, purification of the products, and reaction control.

It is reported that the reaction rate of trans-esterification of triglyceride in the presence of an acid catalyst is very slow, and that it takes a longer time, for example, more than 1 hour for esterification of free fat acid with an acid catalyst in the conventional processes. Further, the conventional systems have a difficulty in removing the by-product, water, during the reaction.

The present invention has solved the disadvantages of the conventional processes above by applying a loop type reactor and a dual frequency ultrasonic irradiation in the reactor. The esterification in the presence of an acid catalyst can be shortened within 1 minute, and the trans-esterification in the presence of an acid catalyst can be shortened within 1 hour. The by-product, water, of the reaction can be removed during operation.

According to the present invention, a substitute fuel can be produced from triglyceride containing less than 5% of free fat acid in the presence of an alkali catalyst. In the process for producing the substitute fuel from the triglyceride, methanol was excessively used in the amount of 60˜100% by weight to fat acid.

In the present invention, the reaction time can be shortened within 1 minute and the amount of methanol was reduced to 10% to fat acid. In addition, the reaction products, substitute fuel and glycerol, are continuously removed during the reaction. Accordingly, the present invention provides a process for high efficiency esterification of free fat acid and for high efficiency trans-esterification of triglyceride.

### DISCLOSURE OF INVENTION

### Technical Problem

An object of the present invention is to provide a process for producing a substitute fuel from a waste oil containing free fat oil with a loop reactor by applying a dual frequency ultrasonic irradiation in the reactor, wherein the esterification and trans-esterification are carried out in a short time, the reactions are proceeded without a catalyst, and the by-product, water, can be removed during the process.

Another object of the present invention is to provide a system for producing a substitute fuel with a loop reactor by applying a dual frequency ultrasonic irradiation, in which the reaction is completed in a shorter time, additional equipments for purification of the excess of methanol are not necessary, and the products, substitute fuel and glycerol, are continuously separated in the reactor.

The above-mentioned and other objects can be achieved in the present invention which is described in detail.

### Technical Solution

The system for producing a substitute fuel in accordance with the present invention comprises a loop reactor system 100 comprising a loop type reactor 102 equipped with at least one dual frequency irradiator to mix the reactants uniformly in the reactor and to accelerate the reaction, a means for feeding waste oil containing free fat acid or fat oil containing triglyceride, and a means for feeding catalyst and methanol; a separation/extraction system 200 for separating the products produced in the loop reactor system into large and small particles and vaporizing low boiling point components; and a phase (layer) separation system 300 for stabilizing the products, equipped with a dual frequency phase separator 302 and a vertical double baffle 303.

A heat exchanger may be preferably installed in the loop reactor to accelerate the reaction by heating the reactants. More than one heat exchanger may be installed in a certain distance.

The means for feeding catalyst and methanol is preferably a porous particle distributor 101, which will increase the mixing effect and flowability of the reactants.

The separation/extraction system 200 comprises a separator 201, an ultrasonic vibrator 202, an ultrasonic passage 203 for separating large and small particles, a heat exchanger 204 vaporizing low boiling point components, and a dual ultrasonic extractor 205 for effective separation.

The present invention shall be in detail described with the accompanying drawings.

### ADVANTAGEOUS EFFECTS

The present invention has advantageous effects in the process and system for preparing a substitute fuel from a waste oil containing free fat acid or vegetable/animal fat oil through esterification or trans-esterification, respectively, in that the reaction is completed in a shorter time by using a dual frequency ultrasonic irradiation, that the use of catalyst and methanol can be minimized, and that a continuous reaction and separation can be carried out.

Any simple changes and/or modifications of the present invention can be easily carried out by an ordinarily skilled person in the art to which the invention pertains, and the changes and modifications are deemed to be within the scope of the claimed inventions.

### BRIEF DESCRIPTION OF THE DRAWINGS

FIG. 1 is a schematic drawing of the system with a loop reactor for producing a substitute fuel in accordance with the present invention.

FIG. 2 is a schematic drawing for showing the porous particle distributor 101 for feeding catalyst and methanol into the loop reactor.

FIG. 3 are drawings for showing dual frequency ultrasonic irradiators; (A) is for irradiator 105, (B) is for irradiator 107, and (C) is for irradiator 103.

FIG. 4 is a drawing for showing a dual ultrasonic extractor 205.

FIG. 5 shows two embodiments of the dual frequency phase separator 302 in the phase separation system 300.

FIG. 6 shows two embodiments of the vertical separator 303 in the phase separation system.

### BEST MODE FOR CARRYING OUT THE INVENTION

The present invention is to provide a system for producing a substitute fuel from a waste oil containing free fat oil in the presence of an acid catalyst, wherein the esterification and the trans-esterification of triglyceride are completed in a shorter time, and wherein the by-product, water, is effectively removed. The present invention is further to provide a system for producing a substitute fuel from a fat oil containing less than 0.5% by weight of free fat acid in the presence of an alkali catalyst, wherein the reaction is completed in a shorter time.

A substitute fuel may be produced from triglyceride or free fat acid. Triglyceride produces substitute fuel through trans-esterification in the presence of an alkali catalyst. However, if an alkali catalyst is used in the process of production of a substitute fuel from free fat acid, the catalyst generates a saponification with the free fat acid. The saponification interferes with the function of the catalyst and results in a poor production of the substitute fuel. Accordingly, when a substitute fuel is produced in the presence of an alkali catalyst, if the raw material contains free fat acid over a certain amount, the excessive amount of the free fat acid should be removed. Up to 2% by weight of free fat acid is allowable. However, it is more preferable to reduce up to 1% by weight of free fat acid. One of the methods of removing the free fat acid is esterification of the free fat acid in the presence of an acid catalyst so as to produce directly substitute fuel.

In the present invention, a substitute fuel is produced from a waste oil containing free fat acid and triglyceride. The free fat acid is converted into the substitute fuel through esterification in a fast reaction rate and the triglyceride through transesterification. The waste oil is uniformly mixed and reacted with methanol and catalyst in the loop reactor 100 equipped with a plural of dual frequency ultrasonic irradiator. The mixing of the reactants is uniformly completed without a physical agitator so as to produce substitute fuel from free fat acid in a shorter time, for instance, within 1 minute. It is reported that it takes more than 1 hour to carry out such reaction in the conventional processes.

In the conventional processes, a large amount of methanol was used, for instance, the ratio of free fat acid to methanol is 1:20 to 1:40 approximately. However, the ratio in the present invention is preferably in the range of 1:10 to 1:20 approximately. Further, the system of the present invention may be operated without a catalyst. The trans-esterification for obtaining a substitute fuel was not economical because of too slow reaction rate. However, according to the present invention, the time for trans-esterification is significantly shortened, which is applicable to a system for producing a substitute fuel.

In the separation/extraction system 200 of the present invention, the unreacted components such as unreacted triglyceride as well as the by-products such as water are separated and removed. An ultrasonic vibrator 202 is installed at the bottom of the separator 201 to separate water and methanol from the substitute fuel and triglyceride. The ultrasonic vibrator is a conventional ultrasonic vibrator with a single frequency. The water and methanol in the separator 201 are converted into small particles by the ultrasonic vibrator 202, and the small particles are exited through ultrasonic passage 203. The heat exchanger 204 vaporizes low boiling point components. The remaining liquid is radically agitated by passing the dual ultrasonic extractor 205. The liquid product is stabilized in the phase (layer) separation system 300. The liquid product is stabilized through the dual frequency phase separator 302, and is separated water and methanol from substitute fuel and triglyceride through the vertical double baffle 303.

In order to increase efficiency of the continuous reaction, a portion of the produced substitute fuel and triglyceride is refluxed into the loop reactor. The free fat acid is completely converted into substitute fuel in a short time and the water produced in the reaction is continuously removed. The reaction time may be controlled depending on the status of reaction. The trans-esterification of triglyceride is carried out simultaneously in the presence of an acid catalyst.

The trans-esterification is one of important reactions for producing a substitute fuel under acid or alkali catalyst, in which triglyceride is converted into substitute fuel and glycerol. The trans-esterification is proceeded faster than the esterification of free fat acid. However, because the trans-esterification is proceeded for more or less 1 hour, such process was not advantageous in the industry.

The present invention provides a process with a high efficiency in a shorter reaction time under an acid or alkali catalyst. A loop reactor equipped with dual frequency ultrasonic irradiators accelerates the reaction by mixing the reactants uniformly. The reactants in liquid states are uniformly mixed and the conversion into substitute fuel is carried out within 1 minute. It is reported that it takes about 30 minutes to 1 hour to do the trans-esterification in the conventional processes. In this trans-esterification, the ratio of fat acid to methanol is about 1:1.6 to 1:2. However, in the present invention using dual frequency ultrasonic irradiators, the ratio is about 1:1.1 to 1:1.2. The trans-esterification according to the present invention can be done in a shorter time without a catalyst. The prepared substitute fuel and glycerol are separated in the separation/extraction system 200 and the phase separation system 300.

An ultrasonic vibrator 202 is installed on the bottom of the separation/extraction system 200 to separate methanol from the liquid product. The ultrasonic vibrator operates with a single frequency. Methanol particles are generated by the ultrasonic vibrator and going up through the ultrasonic passage 203. A heat exchanger 204 is also installed in the system 200 and helps to separate methanol. The substitute fuel and glycerol in the lower part are radically mixed by the dual ultrasonic extractor 205. The products are stabilized and separated in the phase separation system 300 which is equipped with a dual frequency phase separator 302 and a vertical double baffle 303.

In order to increase efficiency of the continuous reaction, a portion of the produced substitute fuel and triglyceride is refluxed into the loop reactor. The fat oil is completely converted into substitute fuel and glycerol in a short time. The reaction time may be controlled depending on the status of reaction.

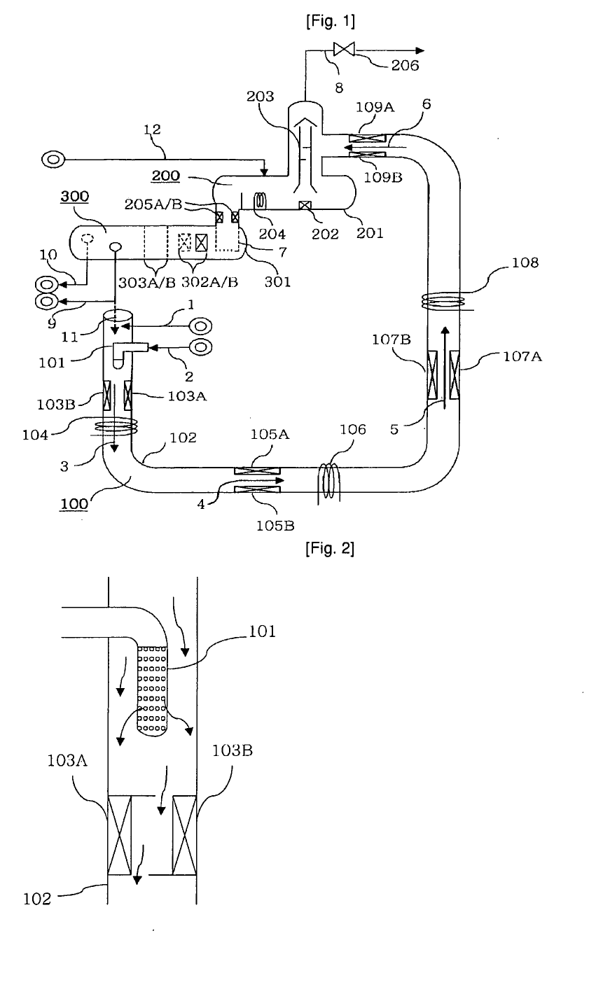

FIG. 1 is a schematic drawing of the system with a loop reactor for producing a substitute fuel in accordance with the present invention. The drawing shows a system for esterification of free fat acid and for trans-esterification of triglyceride.

As shown in FIG. 1, the system for producing a substitute fuel comprises a loop reactor system 100 equipped with a plural of dual frequency irradiators to react the reactants in the reactor, a separation/extraction system 200 for separating continuously the products, and a phase (layer) separation system 300 for stabilizing and separating continuously the products. The size of the system may depend on the amount of reaction, which will be easily utilized by an ordinarily skilled person in the art to which the invention pertains.

The loop reactor system 100 comprises a loop type reactor 102 equipped with at least one dual frequency ultrasonic irradiator to mix the reactants uniformly in the reactor and to accelerate the reaction, a means for feeding waste oil containing free fat acid or fat oil containing triglyceride into the loop reactor, and a means for feeding catalyst and methanol. The separation/extraction system 200 separates the products produced in the loop reactor system 100 into large and small particles, and vaporizes low boiling point components. The separation/extraction system is equipped with a separator 201, an ultrasonic vibrator 202, an ultrasonic passage for separation the particles, a heat exchanger 204 vaporizing the low boiling point components, and a dual frequency ultrasonic extractor 205. The phase (layer) separation system 300 stabilizes and separates the products, which is equipped with a dual frequency phase separator 302 and a vertical double baffle 303.

A plural of heat exchangers 104, 106 and 108 are installed in the loop reactor system 100 to heat the reactants so as to accelerate the reaction rate.

The means for feeding catalyst and methanol is preferably a porous particle distributor 101, which will increase the mixing effect and flowability of the reactants. FIG. 2 is a schematic drawing for showing the porous particle distributor 101 for feeding catalyst and methanol into the loop reactor.

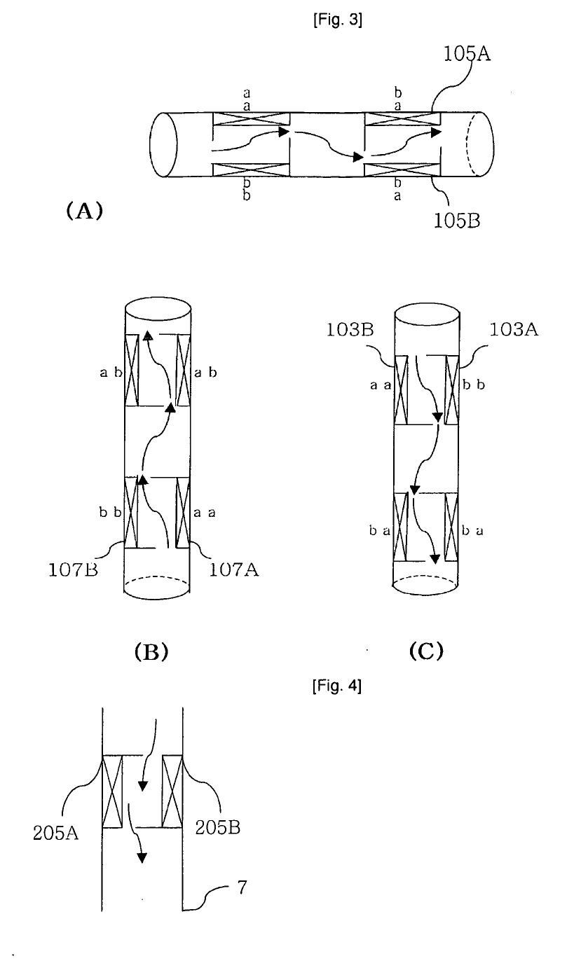

First, a mixture of catalyst and methanol is fed to the porous particle distributor 101 through the inserted pipe 2. The particles of the catalyst and methanol are distributed into the waste oil containing free fat acid. All the reactants pass through the dual frequency ultrasonic irradiator 103A and 103B and heat exchanger 104 in the loop reactor system 100. The reactants flow in the direction 3. The reactants flow in and along the loop reactor 102. Dual frequency ultrasonic irradiator 103 A/B, 105A/B, 107A/B and 109A/B are installed in the loop reactor. Each dual frequency ultrasonic irradiator irradiates crossly two ultrasonic waves with different frequencies. FIG. 3 shows dual frequency ultrasonic irradiators, (A) is for irradiator 105, (B) for irradiator 107, and (C) for irradiator 103.

In the ultrasonic irradiators, if a frequency wave is irradiated in single or dual, the amount of mixing increases, while, if dual frequency waves are irradiated in an irradiator, the efficiency of reaction increases as well as the amount of mixing. The irradiators may be installed inside or outside the loop reactor. However, inside installation is more preferable for protection of the reactor from vibration. Dual frequency ultrasonic irradiators 105A/B, 107A/B and 109A/B are installed in directions 4, 5 and 6, respectively and heat exchangers 106 and 108 are installed there between. The reaction is completed in the loop reactor and the products are fed into the separation/extraction system 200. A baffle may be installed in the dual frequency ultrasonic irradiator for sufficient reaction.

In the separator 201 of the separation/extraction system, an ultrasonic vibrator 202. an ultrasonic passage 203 and a heat exchanger 204 are installed to separate methanol and water from the products. The methanol and water are removed by controlling with a valve 206 through a pipe 8 in the phase of small particles. FIG. 4 is a drawing for showing a dual ultrasonic extractor 205 in the separator 201. The low boiling point components and the liquid in the lower part are radically mixed when passing the extractor 205 and enter into the phase (layer) separation system 300 in the direction 7.

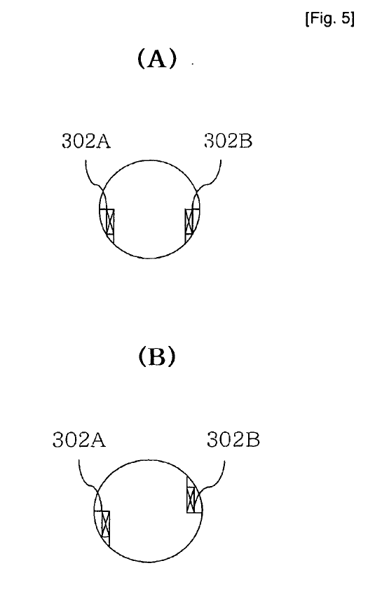

In the phase (layer) separator 301 of the phase separation system 300, the liquid products is stabilized through a dual frequency phase separator 302A/B, and the remaining water and methanol are removed with a vertical double baffle 303 and outlet through pipes 9 and 10, respectively. To increase efficiency of the reaction, a portion of the produced substitute fuel and triglyceride is refluxed into the loop reactor system 100 through pipe 11. FIG. 5 shows two embodiments of the dual frequency phase separator 302, (A) having dual separators at the same level, and (B) having dual separators at different levels.

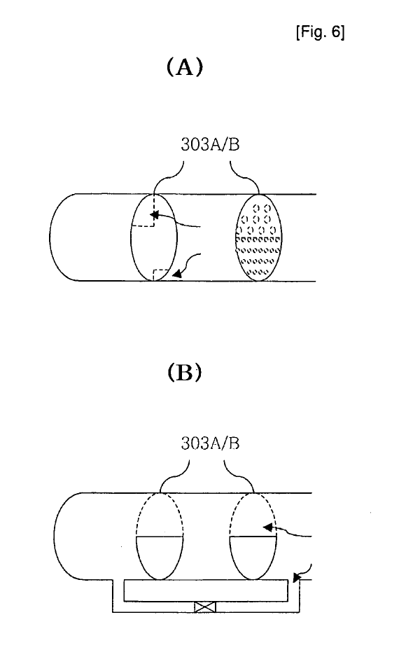

FIG. 6 shows two embodiments of the vertical double separator 303 in the phase separation system 300. FIGS. 6 (A) and (B) are for separation of a mixture with two different gravities into two layers. Such double separators can be utilized by an ordinarily skilled person in the art.

As shown in FIG. 1, the system for producing a substitute fuel from triglyceride through trans-esterification comprises a loop reactor system 100 equipped with a plural of dual frequency irradiators to react the reactants in the reactor, a separation/extraction system 200 for separating continuously the products, and a phase (layer) separation system 300 for stabilizing and separating continuously the products. The size of the system may depend on the amount of reaction, which will be easily utilized by an ordinarily skilled person in the art to which the invention pertains.

First, a mixture of catalyst and methanol is fed to the porous particle distributor 101 through the inserted pipe 2. The particles of the catalyst and methanol are distributed into the waste oil containing free fat acid. All the reactants pass through the dual frequency ultrasonic irradiator 103A and 103B and heat exchanger 104 in the loop reactor system 100. The reactants flow in the direction 3. The reactants flow in and along the loop reactor 102. Dual frequency ultrasonic irradiator 103 A/B, 105A/B, 107A/B and 109A/B are installed in the loop reactor. Each dual frequency ultrasonic irradiator irradiates crossly two ultrasonic waves with different frequencies.

In the ultrasonic irradiators, if a frequency wave is irradiated in single or dual, the amount of mixing increases, while, if dual frequency waves are irradiated in an irradiator, the efficiency of reaction increases as well as the amount of mixing. The irradiators may be installed inside or outside the loop reactor. However, inside installation is more preferable for protection of the reactor from vibration. Dual frequency ultrasonic irradiators 105A/B, 107A/B and 109A/B are installed in directions 4, 5 and 6, respectively and heat exchangers 106 and 108 are installed there between. The reaction is completed in the loop reactor and the products are fed into the separation/extraction system 200.

In the separator 201 of the separation/extraction system, an ultrasonic vibrator 202. An ultrasonic passage 203 and a heat exchanger 204 are installed to separate excess methanol from the substitute fuel and glycerol. The methanol is removed by controlling with a valve 206 through a pipe 8 in the phase of small particles. The low boiling point components and the liquid in the lower part are radically mixed when passing the extractor 205 and enter into the phase (layer) separation system 300 in the direction 7.

In the phase (layer) separator 301 of the phase separation system 300, the liquid products is stabilized through a dual frequency phase separator 302A/B, and the remaining water and methanol are removed with a vertical double baffle 303 and outlet through pipes 9 and 10, respectively. To increase efficiency of the reaction, a portion of the produced substitute fuel and triglyceride is refluxed into the loop reactor system 100 through pipe 11.

The frequency of the ultrasonic of the present invention is preferably in the range of 20˜150 kHz for mixing the reactants in the loop reactor system 100, 250˜1,000 kHz for stabilizing in the phase separation system 300, and over 1 MHz for generating foggy particles in the separation/extraction system 200. The frequency can be varied depending on the physical properties of the reactants.

In addition, the intensity (W/cm²) of the ultrasonic depends on the amount of reaction and electric capacity. In an embodiment of the present invention, dual frequencies of 20 kHz and 28 kHz are used crossly in the loop reactor to accelerate the reaction. The frequencies can be varied depending on the reactants and mass flow. A higher frequency gives a better result in the phase separation system. The phase separation with a dual frequency separator can be carried out in a short time even at the interface. The ultrasonic irradiators should contact with the liquid for a better result. In the separation system 200, 1 MHz ultrasonic is preferably used to concert low boiling point components into small particles so as to separate from high boiling point components.

The invention may be better understood by reference to the following examples which are intended for the purpose of illustration and are not to be construed as in any way limiting the scope of the present invention, which is defined in the claims appended hereto.

### MODE FOR THE INVENTION

### Example 1

A waste oil containing 5% by weight of free fat acid was fed into the loop reactor at the rate of 1,000 g/hr for esterification. Sulfuric acid as an acid catalyst and methanol were added to the free fat acid at the rate of 2.5 g/hr and 112.5 g/hr, respectively. The dual frequency ultrasonic irradiators and heat exchangers were operated in the loop reactor. The irradiators irradiated the ultrasonic with 20 kHz and 28 kHz. The intensity was varied from 0.5 to 20 w/cm². The initial temperature of the reactor started with 30° C., and increased up to 50° C., 80° C. and finally 110° C. by heat exchangers. The reaction was completed with less than 0.5% by weight of free fat acid, and the reaction time was about 3 minutes, which is of course within 5 minutes.

### Example 2

Example 2 was carried out in the same manner as in Example 1 except that the heat exchangers were not operated. The reaction time was about 5 minutes.

### Example 3

Example 3 was carried out in the same manner as in Example 1 except that methanol was added at the rate of 225 g/hr and that the acid catalyst was not added. The reaction time was about 5 minutes.

### Example 4

A triglyceride containing 5% by weight of free fat acid was fed into the loop reactor at the rate of 1,000 g/hr for trans-esterification. Natrium hydroxide as an alkali catalyst and methanol were added to the free fat acid at the rate of 3 g/hr and 100 g/hr, respectively. The dual frequency ultrasonic irradiators and heat exchangers were operated in the loop reactor. The irradiators irradiated the ultrasonic with 20 kHz and 28 kHz. The intensity was varied from 0.5 to 20 w/cm². The initial temperature of the reactor started with 30° C., and increased up to 50° C., 80° C. and finally 110° C. by heat exchangers. The reaction was completed with less than 0.5% by weight of free fat acid, and the reaction time was about 3 minutes, which is of course within 5 minutes.

### Example 5

Example 5 was carried out in the same manner as in Example 4 except that the heat exchangers were not operated. The reaction time was about 3 minutes.

### Example 6

Example 6 was carried out in the same manner as in Example 4 except that methanol was added at the rate of 200 g/hr and that the alkali catalyst was not added. The reaction time was about 3 minutes.

1. A system for producing a substitute fuel from a waste oil containing free fat acid or fat oil containing triglyceride, which comprises:
a loop reactor system 100 comprising a loop type reactor 102 equipped with at least one dual frequency ultrasonic irradiator to mix the reactants uniformly in the reactor and to accelerate the reaction, a means for feeding waste oil containing free fat acid or fat oil containing triglyceride, and a means for feeding catalyst and methanol;
a separation/extraction system 200 for separating the products produced in the loop reactor system into large and small particles and vaporizing low boiling point components; and
a phase (layer) separation system 300 for stabilizing the products, equipped with a dual frequency phase separator 302 and a vertical double baffle 303.

2. The system as defined in claim 1 wherein at least one heat exchanger is preferably installed in the loop reactor to accelerate the reaction by heating the reactants.

3. The system as defined in claim 1 wherein said means for feeding catalyst and methanol is preferably a porous particle distributor.

4. The system as defined in claim 1 wherein said separation/extraction system comprises a separator, an ultrasonic vibrator, an ultrasonic passage for separating large and small particles, a heat exchanger vaporizing low boiling point components, and a dual ultrasonic extractor for effective separation.

5. The system as defined in claim 1 wherein said dual frequency ultrasonic irradiator is equipped with a baffle for sufficient reaction.

6. The system as defined in claim 4 wherein said ultrasonic vibrator is operated with a single frequency for removing low boiling point components.

7. The system as defined in claim 1 wherein said vertical double baffle is installed to separated a mixture with two different gravities as shown in FIG. 6.

8. A process for producing a substitute fuel from a waste oil containing free fat acid or fat oil containing triglyceride, which comprises:
feeding catalyst and methanol through a porous particle distributor;
feeding raw material into a loop reactor for mixing with the catalyst and methanol under a certain temperature and pressure;
reacting the reactants completely using dual frequency ultrasonic irradiators;
controlling the temperature in the reactor using heat exchangers;
removing low boiling point components from the products using a single frequency ultrasonic vibrator;
vaporizing the low boiling point components by heating with a heat exchanger;
mixing radically the remaining products using a dual frequency ultrasonic irradiator for phase separation;
stabilizing the phase layer using a dual frequency ultrasonic irradiator;
separating the phase layer through a vertical double baffle; and
refluxing a portion of the products into the loop reactor.

9. The process as defined in claim 8 wherein said the dual frequency ultrasonic irradiator is installed crossly.

10. The process as defined in claim 8 wherein a single frequency ultrasonic vibrator is further installed for removing low boiling point components.

11. The process as defined in claim 8 wherein said dual frequency ultrasonic irradiator is installed crossly or in zigzag.
